(19) United States
(12) Patent Application Publication
(10) Pub. No.: US 2006/0104771 A1
(43) Pub. Date: May 18, 2006

(54) Portable device for inspection of vehicles

(76) Inventor: Doumis Chapman, Greenville, SC (US)

Correspondence Address: DORITY & MANNING, P.A., POST OFFICE BOX 1449, GREENVILLE, SC, 29602-1449, US

(21) Appl. No.: 10/981,134

(22) Filed: Nov. 4, 2004

(51) Int. Cl. B60P 1/00

(52) U.S. Cl. 414/537

(57) ABSTRACT

A trailer onto which a vehicle may be driven is provided. The trailer can tilt the vehicle to one side for the inspection of vehicles. The trailer includes a portable frame, which supports the vehicle upon the vehicle being driven onto the frame, and at least two platforms disposed on the frame. The platforms provide support on which tires of the vehicle are positionable. A lifting system is operably connected to at least one of the two platforms. The lifting system allows the platform to be controllably moveable to permit tilting of the vehicle to one side.

### TECHNICAL FIELD OF THE INVENTION

This invention concerns a trailer used for inspection of vehicles. In particular, the trailer is used to tilt vehicles so that they may be inspected or X-rayed to check for contraband and explosives.

### BACKGROUND OF THE INVENTION

Smuggling goods across borders using vehicles has been a major concern for border control officials for many countries. Such contraband is usually not stored in the normal storage areas of a vehicle like the trunk or passenger compartment. Rather the smugglers devise complicated schemes and devices to stow the contraband in non-obvious places, for example, the gas tank, the undercarriage of a vehicle, the containers for other fluids of the vehicle, or even the motor. Finding such contraband can be an arduous task even when border control, or security officials have been tipped as to which vehicles are being used to smuggle such contraband. Further, officials must also look for smugglers trying to smuggle items like laundered money out of the country they are leaving. To combat the smuggling of such contraband, custom officials have resorted to inspecting vehicles on a random basis as well as when they are tipped as to potential smuggling activity.

Besides smuggling concerns, a new heightened danger of terrorist attacks has caused many countries to tighten their border and security controls and change their method and procedures of inspecting vehicles crossing borders as well. Explosive devices can be attached to a vehicle or placed inside a vehicle to be detonated at a later time or by impact. Depending on the size of the blast and the explosive used, the explosives can be hard to detect. Security officials in many countries have stepped up inspection of vehicles to divert and prevent such terrorist attacks.

To conduct such inspections, border and security officials have employed different mirror devices and human inspectors to look in, around, and beneath vehicles to try and locate such contraband and explosives. However, these tactics can prove ineffective in locating such contraband. When visually inspecting vehicles, even with mirrors, it is hard to inspect underneath the vehicle. Due to the ineffectiveness of these tactics, border and security officials for different countries have started using different types of inspection methods to increase their chances of intercepting such contraband or explosives.

For example, some customs department have begun a procedure to X-ray vehicles at border crossing when it has a reliable tip that vehicles carrying contraband or explosives may be crossing a border. By X-raying these vehicles, contraband such as drugs and laundered money as well as explosives, or explosive devices, may be detected even within interior components of the vehicle or other vehicle. However, even with the use of such an X-ray machine, it is hard to effectively detect such contraband and explosives when the vehicle is sitting in its normal upright position. Further, these customs department also wants such an X-ray machine device to be portable to allow them to move it from border crossing to border crossing instead of having the expense of investing in an excessive amount of X-ray machines.

Therefore, there is currently a need for a portable device which may be used in combination with an X-ray machine or with visual inspection in order to improve inspection of vehicles for contraband or explosives at border crossing sites.

### SUMMARY OF THE INVENTION

The present subject matter recognizes and addresses the above briefly discussed needs and others for a device used to aid in inspection of vehicles. Accordingly, a general aspect of the present invention is to provide a portable device which may be used to tilt the vehicles to improve the inspection capacity of officials looking for contraband or explosives. Additional aspects and advantages of the invention will be set forth in part in the following description, or may be obvious from the description, or may be learned through practice of the invention.

In an exemplary embodiment, a trailer on which a vehicle may be driven is provided that can tilt the vehicle to one side for inspection of the vehicle. The trailer has a portable frame which supports the vehicle once the vehicle is driven onto the trailer. At least two platforms are disposed on the frame. The platforms can provide the support on which the tires of the vehicle may be positionable. A lifting system is provided that operably connects to the platforms. The lifting system allows each of the at least two platforms to be independently controllable to permit the raising of the vehicle or the tilting of the vehicle to one side. It has been found that, by using such a device to tilt the vehicle to one side while it is being X-rayed or inspected in another manner, then it is much more likely that contraband or explosives can be found within a given vehicle. It has been found that, by using such a device to tilt the vehicle to one side while it is being X-rayed or inspected in another manner, then it is much more likely that contraband or explosives can be found within a given vehicle.

In further embodiments, at least one ramp may be disposed to an end of the frame of the trailer. The at least one ramp will provide a surface to permit the vehicle to be drivable on the at least two platforms. It may be beneficial to have two ramps disposed at opposing ends of the frame of the trailer to allow the vehicle to be driven onto and off of the trailer without placing the vehicle in reverse. Such ramps may be attached to the portable frame and may be raised or lowered either mechanically or automatically. Each ramp may include two rails that are in alignment with the at least two platforms to permit the vehicles to be drivable onto the platforms. To make it easier to drive the vehicles onto the trailer, the ramps may provide a general slope from a ground surface up to the trailer. To make the trailer that has these ramps disposed thereon more readily transportable, the rails may be foldable to shorten their effective length during travel. To help extend the ramps, a support hinge may be fixedly attached to the rails, near the portion of the rails where a hinge permits the rails to be folded.

The lifting system used to raise the platforms may have a control unit which is operably connected to a drive unit that is coupled to the at least two platforms. The control unit engages the drive unit when one of the at least two platforms is to be raised from the frame or lowered back to the frame. In such embodiments, the lifting system may be a hydraulic system. The hydraulic system may employee at least one pump in its drive unit. The pump may be operably connected to at least one cylinder that is connected to each of the at least two platforms. For example, in one embodiment, two pairs of cylinders may be disposed in the frame of the trailer with each of the pairs of cylinders being attached vertically beneath one of the at least two platforms. In this way, the platforms may be raised in a level manner in order to raise the vehicle or tilt the vehicle to one side or the other. Ideally, only one platform will need to be raised at a time in order to tilt the vehicle to one side. However, depending on the angle on which the vehicle is being inspected or X-rayed, both platforms may be raised or lowered to obtain the desired tilt of the vehicle. Therefore, the lifting system allows each of the at least two platforms to be independently raiseable above the frame and lowerable to the frame in a level manner to permit the tilting of the vehicle to one side.

In a further embodiment, two cylinders may be placed in the frame at an angle wherein each of the cylinders is operably connected to a swing arm disposed between the frame and one of the at least two platforms. By the hydraulic system using a single cylinder for each platform in this manner, the cylinder may push the swing arm from its resting position causing it to pivot around the location where the swing arm is attached to the frame, thereby pushing the platform connected thereto upward. As the cylinder is deactivated, the piston of a cylinder will pull the swing arm back down, thereby lowering the platform to its lower position. In this manner, a single cylinder can be used to raise a platform in a level manner while still providing enough strength and force to tilt the vehicle to one side.

To increase the efficiency of the trailer as well as preventing any undue down time, two pumps may be provided. The primary pump may be used the majority of the time to ensure the proper operation of the trailer. However, a secondary pump may also be provided which may be used to engage the two platforms when the primary pump is taken out of service.

To supply power to the hydraulic system, batteries may be used which are operably connected to the hydraulic system. These batteries may also be attached to a generator, which may be carried within the frame of the trailer. The generator may be used to recharge the batteries once they begin to run low by using rechargeable batteries. The trailer may be transported to remote locations without having to worry about finding a power supply to operate a trailer. By having a generator also carried within the frame of the trailer, the rechargeable batteries may be recharged at remote locations. Therefore, the trailer can be used in remote locations for extended periods of time.

To allow the trailer to be pulled by a towing vehicle, a tongue is provided which has a coupler extending therefrom. The coupler allows for the trailer to be hitched to a trailer hitch on the towing vehicle. The coupler may be a removable coupler to prevent the tongue and coupler from interfering with the use of the trailer during an inspection mode in which vehicles, or other vehicles, are driven onto the trailer to be inspected. In such embodiments that use a removable coupler, a kill switch may be provided which is engaged by the coupler to kill the power supplied to the lifting system. In this manner, the lifting system cannot operate while the coupler is engaging the kill switch. This prevents the lifting system from operating while the trailer is in transit.

In some embodiments, the lifting system may also engage the ramps thereby automatically lifting the ramps from a lower position when the trailer is in inspection mode to an upper position for when the trailer is to be placed into transit. For such embodiments, a kill switch which is attached to the frame can be particularly important to prevent the unintentional lowering of the ramps when the trailer is mobile.

The frame of a trailer may be disposed upon a plurality of axles to support the weight of the vehicles being driven onto the trailer for inspection. To further stabilize the trailer, retractable jacks may be disposed on opposite ends of the frame. The jacks may be rotated from a traveling position to a stabilizing position and then extended to brace the trailer to add better support for when vehicles are driven onto the trailer for inspection.

Through the use of such a trailer as described above, vehicles may be tilted to one side in order to increase the effectiveness of their inspection at border crossings or in other places where vehicles need to be inspected for contraband or explosives. Other features of the present invention will be described in greater detail below through the use of the appended Figs.

### BRIEF DESCRIPTION OF THE DRAWINGS

FIG. 1 shows a perspective view of an embodiment of a trailer according to the present invention with the ramps extended so that the trailer may receive vehicles to be inspected;

FIG. 2 shows a perspective of the trailer of FIG. 1 with a platform raised in order to tilt a vehicle;

FIG. 3 shows a side view of the trailer of FIG. 1 with the trailer being prepared for transit;

FIG. 4 shows a portion of an embodiment of the lifting system used for a trailer of FIG. 1;

FIG. 5 shows a top view of the trailer of FIG. 1;

FIGS. 6a and 6b show an embodiment of a tongue and coupler portion of the trailer of FIG. 1;

FIG. 7 shows a cross-sectional side view of a portion of the trailer of FIG. 1;

FIG. 8 shows a schematic view of a lifting system used in a trailer according to the invention;

FIG. 9 shows an embodiment of a lifting system used in a trailer according to the invention; and

FIG. 10 shows a further embodiment of a lifting system used in a trailer according to the invention.

### DETAILED DESCRIPTION

Reference will now be made in detail to the presently preferred embodiments of the invention, one or more examples of which are shown in the figures. Each example is provided to explain the invention, and not meant as a limitation of the invention. In fact, features illustrated or described as part of one embodiment can be used with another embodiment to yield still a third embodiment. It is intended that the present invention cover such modifications and variations.

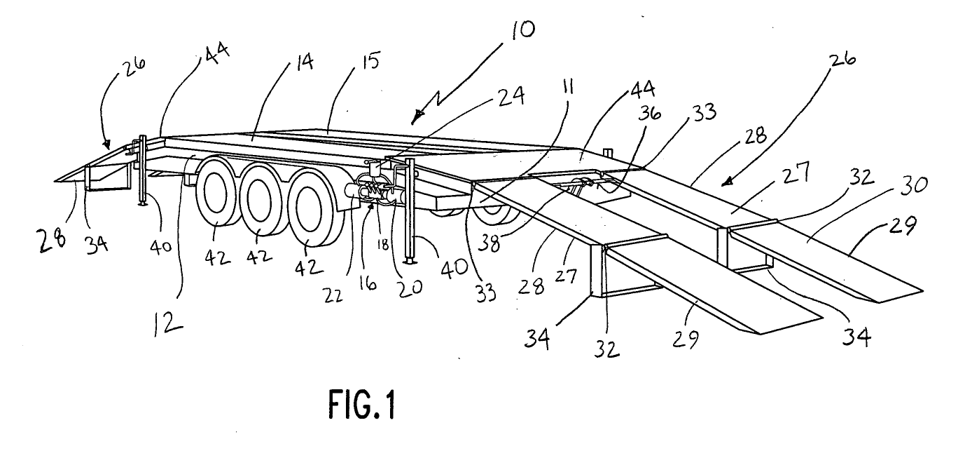

FIGS. 1, 2, and 3 illustrate a portable device, generally 10, which may be used for inspection of vehicles at border crossings or at other locations where security of the location may be at risk. The portable device 10 allows vehicles to be driven thereon and then tilted to allow a more thorough inspection. The inspection may be conducted manually or mechanically. For example, an X-ray machine may be used to take an X-ray of the vehicle. By tilting the vehicle, the X-ray taken of the vehicle may more readily expose contraband or explosives hidden in the running board, dashboard, gasoline tank, etc., than X-rays taken of the vehicle in its normal operational upright position.

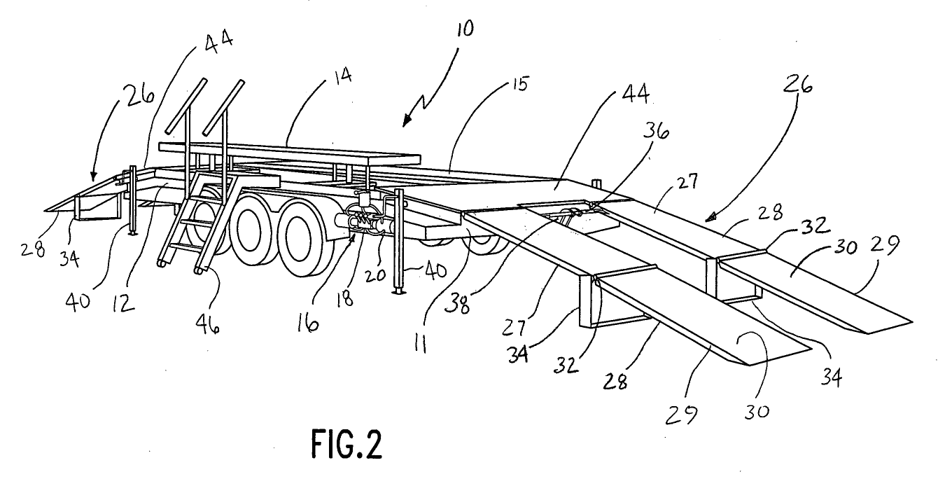

To provide this tilting action, the trailer in the embodiment shown can provide two platforms 14, 15 on a top of the trailer 10. Further, ramps 26 are provided at ends 11 of a frame 12. The ramps 26 allow vehicles to be driven onto the trailer so that the tires of the vehicle rest upon the platforms 14, 15. A lifting system 16 is operably connected to the two platforms 14, 15 so that each of the platforms may be independently controllable to permit the tilting of the vehicle to one side or the other. To tilt a vehicle to its side, either platform 14 or 15 may be raised from a down position shown in FIG. 1 to a raised position as shown by platform 14 in FIG. 2. In some embodiments, only one of the platforms may be raisable.

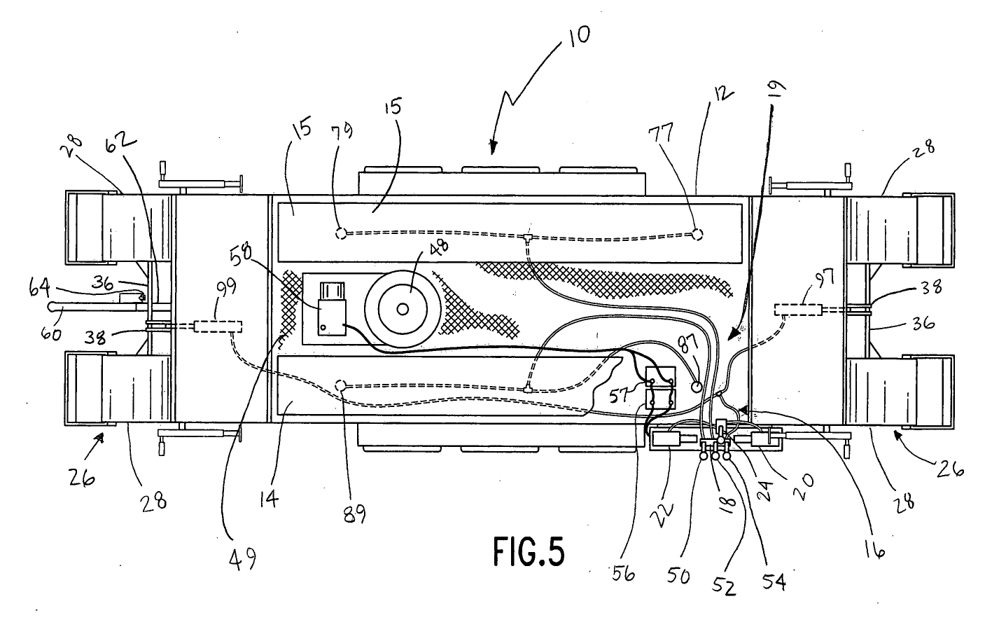

In the exemplary embodiment, the lifting system 16 has a control unit 18 connected to a drive unit 19 (see FIG. 5). The control unit 18 activates the drive unit 19 to raise the platforms 14, 15 to a raised position and to lower the platforms 14, 15 to a down position. In this manner, lifting system 16 may lift one or both of the platforms 14, 15 thereby causing the vehicle placed on two platforms to tilt to one side. Once the vehicle has been inspected, either visually, by X-ray, and/or by some other method, the lifting system may lower the platform 14 and the vehicle may be driven off one of the ramps 26 of the trailer 10.

To render the trailer mobile, the frame 12 of the trailer 10 may be disposed upon at least one axle 43. The number, size and construction of the axles 43 may vary depending on the design of the trailer and its expected load. In the exemplary embodiment shown in FIGS. 1, 2, and 3, three axles 43 are provide with tires 42 attached thereto. The axles 43 are positioned close together in the middle of the trailer to maximize the amount of load the trailer can support during the tilting process. In such an embodiment, the maximum weight which the trailer can withstand based on the size, construction, and location of axles 43 can be over 340 lbs. of ton weight. The more central location of the axles 43 creates added support for the raising and/or tilt of the vehicles or platforms 14, 15. The placement of the axles 43 is also important, because it allows for the correct balance for towing the trailer 10. As stated above, the number of axles 43 and their placement may vary depending on the design of the trailer 10 based on the expected capacity of the trailer 10, the towing balance and other factors.

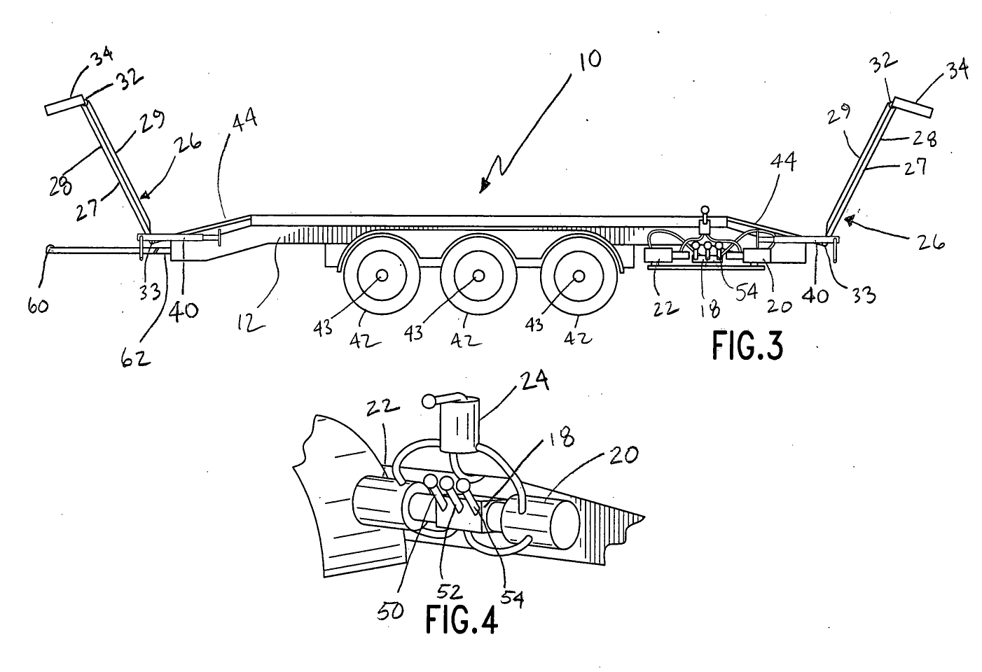

It may be beneficial if the placement of the axles 43 are such that the trailer 10 can sit level once it is removed from the towing vehicle. Once the trailer has been towed to the desired locations and inspections are ready to begin, the trailer 10 can be further stabilized. To stabilize the trailer 10 during an inspection mode, retractable jacks 40 may be placed on either side of the ends 11 of the frame 12. In inspection mode as shown in FIGS. 1 and 2, the ramps 26 may be extended to a ground surface to allow a vehicle to be driven onto the trailer 10. Before a vehicle is allowed to approach the trailer 10, the retractable jacks 40 may be rotated from a traveling position as shown in FIG. 3 to a stabilizing position as shown in FIGS. 1 and 2. The retractable jacks extend downward to the ground surface in a locking manner to stabilize the trailer 10. The jacks 40 may be rotated and extended manually as shown in FIGS. 1 through 3 or may be rotated and extended by some other mechanical activation such as through the use of hydraulics. Other embodiments of jacks may also be used such as those used with backhoes or boon trucks. Once the trailer has been used for the inspection, the jacks 40 may be retracted and rotated into their traveling positions and the ramps 26 raised from the inspection position as shown in FIGS. 1 and 2 to their traveling position as shown in FIG. 3.

The ramps may take on many different forms as long as they are sturdy enough to withstand the weight of a vehicle such as a vehicle or truck being driven onto the ramps as the vehicle is being placed on the trailer 10. In the exemplary embodiment shown in FIGS. 1, 2, and 3, the ramps 26 include two foldable rails 28 disposed on either end 11 of the trailer 10. The rails 28 are in alignment with the platforms 14, 15. Both rails 28 and the platform 14, 15 are wide enough and are properly spaced so that the axle tracks of the vehicle, or distances between center lines of tire treads measured across an axle, for most vehicles are supported by not only the platform 14, 15, but also by the two parallel rails 28 for each of the ramps 26. To prevent having too steep of an incline between the ground surface and the platforms 14, 15 of the trailer 10, the rails 28 should be long enough to provide a gentler slope up to the platforms 14, 15 of the trailer 10.

To ensure that the slope is not too steep, while also shortening the length of the rails 28 of the ramps 26, the trailer 10 may have intermediate sloped surfaces 44 located at the ends 11 of the frame 12 between the platforms 14, 15 and the rails 28 of the ramps 26. The angle of the sloped surfaces 44 also creates a gentle slope. The sloped surfaces 44 can serve several functions. For example, they extend the ends of the trailer 10 closer to a ground surface. This permits the trailer to have a greater height to increase the clearance of the trailer 10 and improve inspection capabilities. At the same time, the sloped surfaces 44 prevent the slope of the ramps 26 for being too large, which can cause clearance problems for vehicles being driven onto the trailer 10. The sloped surfaces 44 also allow the rails 28 of the ramps 26 or other ramps to be a length which can be more manageably handled.

To make the use of the ramps 26 easier, the rails 28 may be divided into a top portion 27 and a lower portion 29. These portions 27, 29 of each rail 28 may be removably attachable to each other or may be hinged along a hinge 32 between the two positions 27, 29 as shown in the exemplary embodiment. By having the top portions 27 hinged by hinge 32 to the bottom portions 29 of the rails 28, the rails 28 may be foldable to a traveling position as shown in FIG. 3 making the transport of the trailer 10 much easier. Due to a long length of the rails 28, a support 34 may be attached proximal to the hinge 32 to help support the weight of the vehicle as it is driven up or down the ramps 26. The support 34 can take on many forms and may be permanently attached to the rails 28 or may be removable therefrom. The ramps 26 provide a surface 30 on the rails 28 to allow the vehicles to be driven onto the trailer 10 as well as off the trailer 10. Also, with the retractable jacks 40, the ramps 26 may also be controlled either manually or automatically. For example, the ramps 26 may be controlled by the lifting system 16 to allow them to be automatically lifted from an inspection position to a traveling position and vice versa.

FIGS. 4 and 5 in conjunction with FIGS. 1, 2, and 3 illustrate a lifting system 16 in the exemplary embodiment shown. In the embodiment shown, the lifting system 16 is a hydraulic system. As stated earlier, the lifting system 16 includes a control unit 18 and a drive unit 19. The control unit has control levers 50, 52, 54 for raising and lowering the platforms, 14, 15 as well as the ramps 26. In other embodiments, other type of control units 18 may be used such as push button controls, remote controls, computer interface controls, etc.

The control unit 18 is connected to the drive unit 19 shown in FIG. 5 to control the raising and lowering of the top platforms 14, 15, and the ramps 26. The drive unit 19 has at least one pump 20 for driving the hydraulic system. In the embodiment shown, a primary pump 20 and a secondary pump 21 are provided. A pump control 24, which can shift power between the primary pump 20 and the secondary pump 21, can be employed. The pump control 24 can have a neutral position where power is not supplied to either pump 20, 21, thereby preventing mobilization of the platforms and/or ramps. The pumps 20, 21 are connected by control unit 18 to fluid lines (shown schematically), which provide hydraulic fluid to different cylinders 77, 79, 87, 89, 97, and 99 that actively raise and lower the platforms 14, 15 and the ramps 26. Depending on which lever 50, 52, 54 on the control unit 18 is activated, the different platforms 14, 15 or ramps 26 are lifted or lowered.

For example, if the lever 50 is activated, then the pump 20 pumps fluid into cylinders 87, 89, which are attached and placed vertically below the platform 15. The cylinders 87, 89 push the platform 15 upward. Once the platform 15 is at a desired height, the handle may be returned to a resting position. The platform 15 will stay in its raised position until such time as the handle 50 is pushed in the opposite direction than the direction in which it was originally pushed to raise the platform. Once the handle 50 is pushed in this opposite direction, the cylinders 87, 89 will lower causing the platform 15 to lower to its original down position.

In a similar manner, lever 52 may be activated in one direction to raise platform 14. The cylinders 77, 79 are carried in the frame 12 and are extendable in a vertical direction. The lever 52 activates the pump 20 to pump fluid into cylinder 77 and cylinder 79. The cylinders 77, 79 extend vertically upward pushing the platform 14 upward. The lever 52 may then be activated in the opposite direction allowing the cylinders 77, 79 and the platform 14 to be lowered back to the down position on the frame 12.

To control the ramps 26, lever 54 may activate the pump 20 to pump fluid to cylinder 97 and cylinder 99. In the embodiment shown for the ramp 26 having rails 28, the cylinders 97 and 99 are each connected to a swivel arm 38 which is in turn fastened to a control bar 36. Each control bar 36 is fastened between the rails 28 of a ramp 26. A control bar 36 allows the rails 28 of the ramp 26 to be raised and lower in unison.

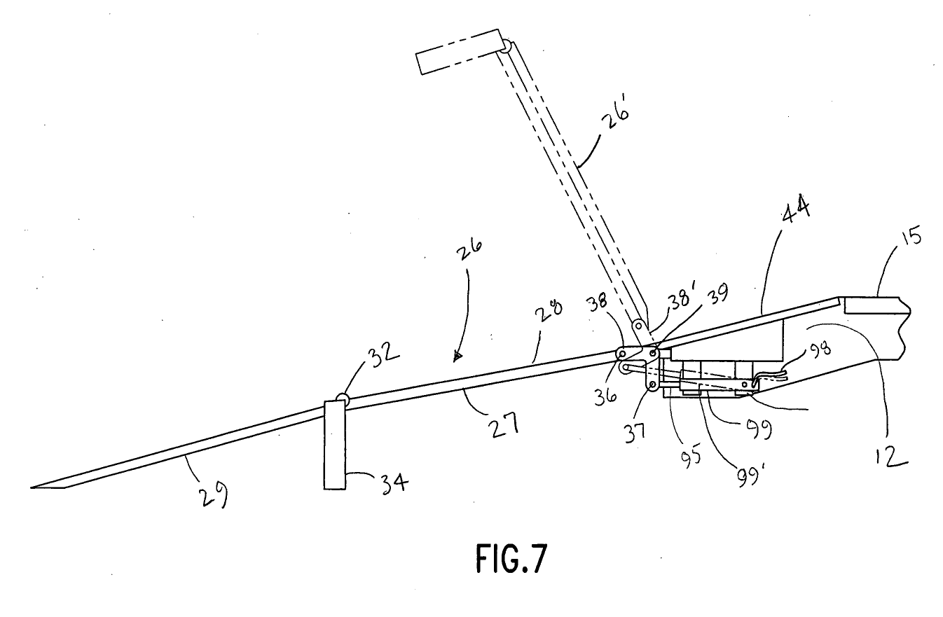

As can be seen in FIG. 7, the swivel arm 38 is connected to frame 12 at a pivot point 39. To raise the ramp 26 from its down position in an inspection mode, the lower portion 29 of each rail 28 may be folded at the hinge 32 back onto the upper portion 27 of the rails 28. Once the lower portions 29 are folded onto the outer portions 27, then handle 54 may be activated causing the pump 20 to supply fluid to the cylinders 97, 99. As can be seen from FIG. 7, the hydraulic fluid is provided to the cylinder 99 causing the piston arm 95 of the cylinder 99 to extend outward from the cylinder 99 thereby pushing the swivel arm 38 outward and upward causing the swivel arm 38 to pivot at pivot point 39. Cylinder 99 extends the piston arm 95 causing the cylinder 99 to move into a position 99′ which, in turn, causes the swivel arm 38 to move into the position 38′ that raises the ramp 26 into the traveling position 26′.

Once the ramps are in an upward traveling position, the trailer 10 may be pulled to a desired location where the ramps 26 may be lowered by pulling the lever 54 in the reverse direction causing the piston arm 95 to retract pulling the swivel arm 38 to a down position as shown in FIG. 7. When the ramp 26 is in the downward position, the supports 34 should contact the ground surface surrounding the trailer. The lower portion 29 of each rail 28 may then be unfolded to also extend to the ground surface on which the trailer rests.

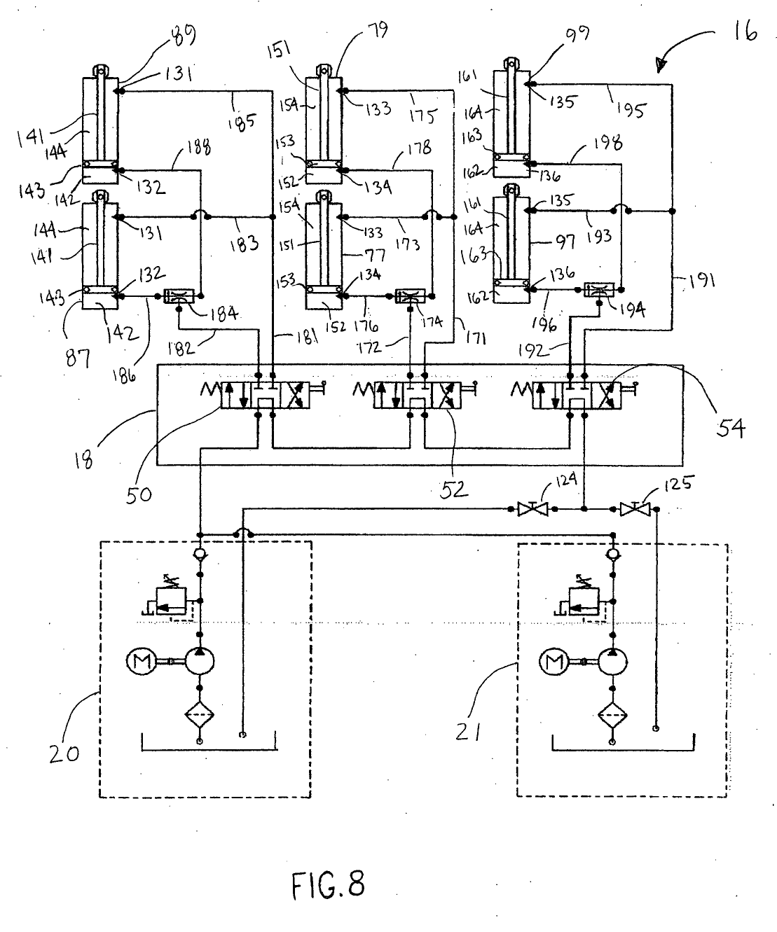

FIG. 8 is a more detailed schematic view of the lifting system used in the trailer. Lifting system 16 has the primary pump 20 and the secondary pump 21 either of which can be used to supply hydraulic fluid to cylinders 77, 79, 87, 89, 97, 99 of the lifting system 16. The pumps 20, 21 are connected to a control unit 18. The control unit has three different activation mechanisms 50, 52, 54 which can be push buttons, levers, switches, remote controls, computer interface controls, and the like. As stated above, different control mechanisms 50, 52, 54 may be engaged to activate the pump to control the movement of the platforms and/or ramps. For example, if the activation mechanism 50 is activated to raise the platform attached to cylinders 87, 89, the pump will send hydraulic fluid to a main line 182 which feeds a flow divider 184 that evenly splits the hydraulic fluid and feeds it through lines 186 and 188. Lines 186 and 188 are connected to the cylinders 87, 89, respectively, through connection feeds 132. Each of cylinders 187, 189 have a piston 143 with a piston arm 141 extending from that piston 143 through each of the cylinders 87, 89. As fluid is feed in through the feed connections 132, the pistons 143 are raised within the cylinders 187, 189, thereby pushing the piston arms 141 upward from the cylinders 87, 89. In this manner, the platform attached to the piston arms 141 is raised as the fluid fills the bottom sides 142 of the cylinders 189, 187 below the pistons 143.

To lower the platform, activation mechanism 50 is engaged so that pump 20 feeds hydraulic fluid through line 181 which splits the flow of fluid between line 183 and line 185. The lines 183 and 185 feed the hydraulic fluid through feed connections 131 into the top sides 144 of the cylinders 87, 89 above the pistons 143. Since the fluid is coming through feed connections 131 of the cylinders 87, 89, the hydraulic fluid forces the pistons 143 as well as the piston arms 141 downward within the cylinders 87, 89, which, in turn, forces the hydraulic fluid in the bottom sides 142 of the cylinders 87, and 89 back through their respective feed lines. In this manner, the cylinders 87, 89 lower the platforms attached thereto to a desired level.

In a similar manner, activation mechanism 52 may be used to facilitate the raising of the second platform attached to cylinders 77, 79. Activation mechanism 52 may be engaged so that pump 20 is activated to feed hydraulic fluid through main line 172 into a flow divider 174, which evenly divides the flow of the hydraulic fluid between line 176 and line 178. Lines 176, 178 feed the hydraulic fluid through feed connections 134 into cylinders 77, 79 on bottom sides 152 of the cylinders 77, 79 below pistons 153. As the hydraulic fluid fills the bottom sides 152 of the cylinders 77, 79, the pistons 153 are pushed upwards causing piston arms 151 of the pistons 153 to extend upward, thereby pushing the platform attached to the cylinders 77, 79 to a desired level. To lower the platform, activation mechanism 52 is engaged so that the pump 20 feeds main line 171 which supplies hydraulic fluid to line 173 and line 175. Lines 173, 175 feed hydraulic fluid through feed connections 133 to the top sides 154 of the cylinders 77, 79 above the piston 153. As the hydraulic fluid is fed under pressure and the top sides 154 of the cylinders 77, 79 are filled, the pistons 153 are pushed downwards thereby forcing the piston arms 151 to lower the platform to a desired level. The hydraulic fluid fed to the topsides 154 is under enough pressure to cause the hydraulic fluid in the bottom sides 152 of the cylinders 77, 79 to begin to drain until such time that the piston 153 rests at a desire level thereby holding the platform at a desired level.

Activation mechanism 54 can control the ramps in a similar manner. To raise the ramps which are connected to the lifting system 16, activation mechanism 54 is engaged so as to activate pump 20 to feed hydraulic fluid through main line 192 to flow divider 194 which divides the hydraulic fluid between line 196 and line 198. Lines 196 and 198 feed hydraulic fluid through feed connections 136 into the bottom sides 162 of the cylinders 97, 99 below pistons 163. As the bottom sides 162 of the cylinders 97, 99 fill, the pressure is applied to the pistons 163 within the cylinders 97, 99 causing the pistons 163 to rise. As the pistons 163 rise, the piston arms 161 are forced outward thereby pushing the ramps connected to the piston arms 161 upward. To lower the ramps, the activation mechanism 54 is engaged so that the pump 20 feeds hydraulic fluid to main line 191 which divides the hydraulic fluid between lines 195 and 193. Lines 193 and 195 feed hydraulic fluid through the connections 135 into top sides 164 of the cylinders 97 and 99 under pressure. As the top sides 164 of the cylinders 97, 99 fill, the hydraulic fluid pushes the cylinder 163 downward thereby causing the ramps connected thereto to lower. The hydraulic fluid in the bottom sides 162 of the cylinder 97, 99 is forced out as the hydraulic fluid fills the top sides 164 of the cylinders 97, 99. In this way, the ramps may be lowered in a controlled manner.

Ball valves 124, 125 control which pump will provide hydraulic fluid to the lifting system 16. If ball valve 124 is open and ball valve 125 is closed, primary pump 20 will provide the hydraulic power to control the cylinders and therefore the platforms and ramps. If ball valve 124 is closed and ball valve 125 is open, secondary pump 21 will then supply the hydraulic fluid to power the cylinders for the platforms and ramps. In this manner, one pump may be taken down to be serviced while the other pump runs the lifting system for the trailer.

As shown in FIG. 5, to supply power to the lifting system 16 at least one battery 56 may be supplied. In the exemplary embodiment shown, two batteries 56, 57 are operably attached to the lifting system 16. In order to prevent the batteries 56, 57 from dying, a generator 58 may be attached to the batteries to recharge the batteries on a periodic basis. The generator may be placed on a storage area 49 between the two platforms 14, 15. The storage area may also supply space for such things as portable stairs 46 and spare tire 48.

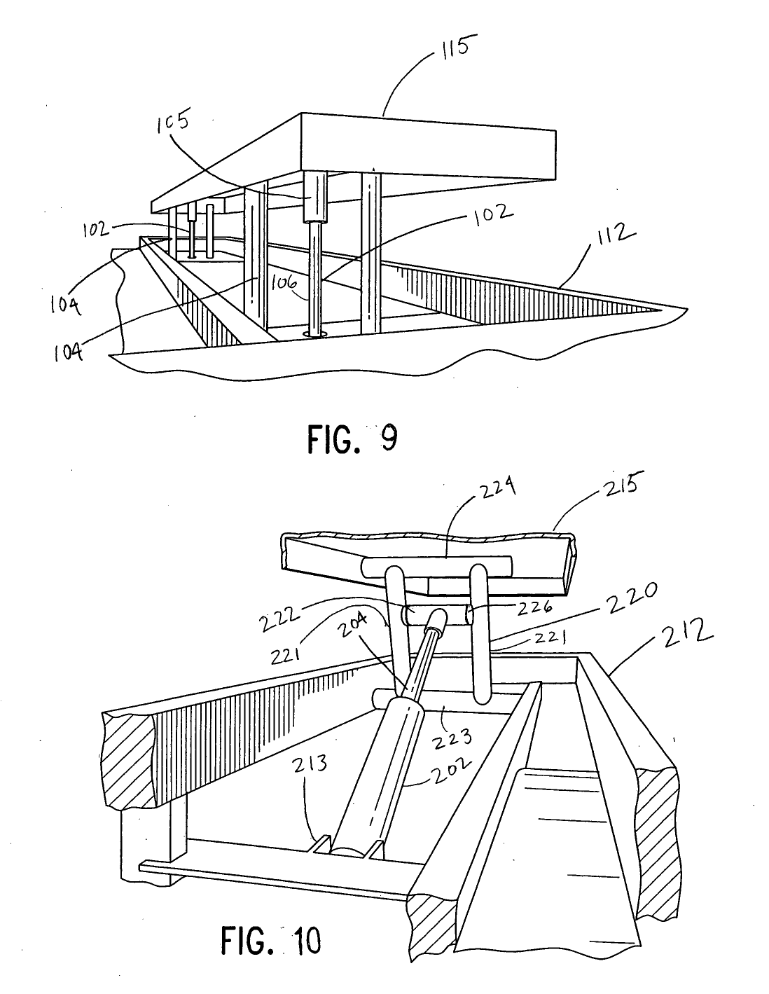

As stated earlier, different lifting systems may be employed such as a motor driven screw system for lifting the platforms and possibly the ramps or some other type of mechanical or electromechanical system. Further, different types of hydraulic systems may be used for the lifting system 16. For example, FIGS. 9 and 10 illustrate two different types of placements for cylinders in a hydraulic system for different hydraulic systems. In FIG. 9, two cylinders 102 shown only by the piston arms 106 extending from the frame 112 are placed in the frame 112 in a vertical position with the piston 106 secured in a sleeve 105 which is disposed on the underside of the platform 115. When the cylinders 102 are activated the piston arms 106 push the platform 115 up in unison. In this manner, the platform 115 is raised in a leveled and controlled fashion. To stabilize the platform 115 in its raised position, support columns 104 are position on either side of the piston arms 106 of each of the cylinders 102. The support columns 104 help to stabilize the platform 115 when the platform 115 is raised to tilt a vehicle.

As stated before, the platforms may be controlled individually by the control unit. By using a hydraulic lifting system with two cylinders placed underneath each platform, there is more than enough power to lift almost any weight vehicle which may be driven onto the trailer 10 and the platforms. As seen in FIG. 8, the flow dividers 174 and 184 split the flow of hydraulic fluid from the main lines 172 and 182 to feed the cylinders 77, 79 and cylinders 87 and 89, respectively. The flow dividers 174 and 184 direct enough hydraulic fluid to their respective cylinders to raise the associated platform in a leveled manner under the weight of the vehicle, which is placed upon the trailer. Once the vehicle has been inspected and/or X-rayed, the respective cylinders will lower the platform in a controlled level manner.

In FIG. 10, a single cylinder 102 is provided for each platform to raise and lower the platform which is attached thereto. The cylinder 202 is rotatably attached to the frame 212, a piston arm 204, which extends from the cylinder 202 is secured into a rotatable sleeve 222. The rotatable sleeve 222 is fit on a cross bar 226 of a swing arm 220, which is rotatably attached to the frame 212 as well as a platform 215. The swing arm 220 has two support members 221 spaced at a sufficient distance to adequately support the weight that is placed upon the platform 215 in a balanced manner, when a vehicle is on the trailer. The cross bar 226 is located between the two support members with the support members 221 attached to pivot bar 223 attached to the frame 212 and pivot bar 224 attached to the platform 215. The pivot bars 223, 224 allow the swing arm to rotate. At the opposite end of the platform 215, another swing arm is attached to both the platform 215 and the frame 212. However, no cylinder engages the other swing arm.

When a control unit is engaged to raise the platform 215, the piston arm 204 in the cylinder 202 extends outward from the cylinder 202 rotating the swing arm 220 upward about the pivot bar 223 attached to the frame 212. As the swing arm 220 is rotated upward, the platform 215 is raised. Also, as the swing arm 220 is rotated upward, the cylinder 202 will also rotate at a point where it is connected to the frame at the holding member 213. The cylinder 202 should have enough strength and holding capacity to support the platform 215 when the weight of the vehicle is rested upon the platform 215. The platform 215 should also be constructed of materials sturdy enough not to bend excessively under the weight of the vehicle. As the swing arm 220 is raised, the other swing arm attached to the platform 215 is also raised and is used to further support the vehicle that is disposed thereon.

In such an embodiment as is shown in FIG. 10, the lifting system will have a different construction than shown in FIG. 5 or 8. In particular, each cylinder may be directly connected to hydraulic lines that supply the fluid from the pump and the control unit attached thereto to raise and lower the associated platform. So unlike the other embodiment described above, flow dividers are not necessary for the cylinders used to raise the platforms of the trailer. Other constructions and assemblies of a cylinder within a hydraulic lifting system may be used to raise the platforms of the trailers as well as the ramps disposed thereto if such ramps are provided.

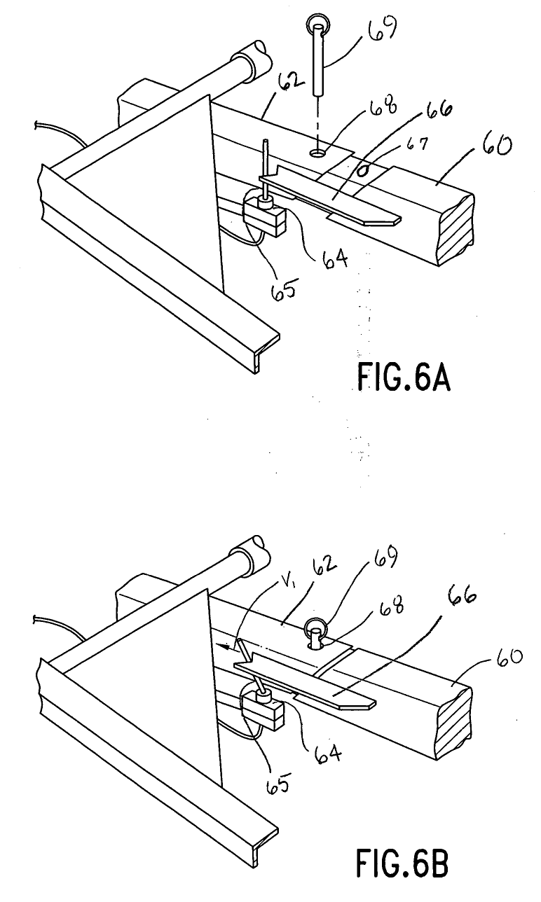

In order to pull the trailer, a tongue 62 and a coupler 60 is attached to the trailer 10 to allow the trailer 10 to be pulled behind a towing vehicle. The coupler 60 will fit onto a trailer hitch to allow the trailer 10 to be pulled. In the embodiment shown in FIGS. 3, 5, 6a, and 6b, the coupler portion 60 is removable from the tongue portion 62 so that the tongue portion 62 does not interfere with the ramps 26. Further, a kill switch 64 may be provided on the tongue 62 to immobilize the lifting system so that the lifting system cannot operate while the trailer is in transit. To operate the kill switch 64 in the embodiment shown, a toggler 65 of the kill switch 64 is activated by the V-shaped press 66 attached to the coupler portion 60 when the coupler portion 60 is inserted into the tongue portion 62. As the V-shaped press 66 pushes the toggler 65 in the direction V, the kill switch kills the power supply to the control unit of the lifting system. While the kill switch is shown in conjunction with the tongue portion 62 and coupler portion 60, it should be noted, a kill switch to immobilize the lifting system may be employed in some other arrangement.

The tongue portion 62 and its coupler portion 60 have locking apertures 68 and 67, respectively, which are aligned when the coupler portion 60 is slid into the tongue portion 60. A locking pin 69 may then be inserted through the locking aperture 68 in the tongue portion 62 as well as a locking aperture 67 in the coupler portion 60 once the locking apertures 67, 68 are aligned. In this manner, the coupler 60 may be securely fastened to the tongue portion 62 to allow the pulling of a trailer 10. Once the trailer 10 is at a desired location the locking pin 69 may be removed thereby allowing the coupler 60 to be pulled from the tongue portion 62. As the coupler 60 is pulled from the tongue portion 62, the V-shaped press 66 disengages the toggler 65 of the kill switch 64 thereby returning power to the lifting system. In this manner, the trailer 10 may be transported in a safe manner without worry of the ramps or platforms being activated during transit.

As stated above the trailer disclosed above, and any of its variations can be used to help security officials at border crossings or other locations where vehicles need to be inspected. The trailer can be used to raise and tilt vehicles to allow them to be more thoroughly inspected whether manually or through some other inspection device or technique. By having the ability to tilt the vehicles to be inspected, more drugs, explosives, or other contraband can be detected, especially when used in combination with inspection devices such as X-ray machines.

It would be appreciated by those skilled in the art that various modifications and variations can be made in the present invention without departing from the scope of the invention. It is intended that the present invention include such modifications and variations as come within the scope of the appending claims and their equivalents.

What is claimed:

1. A portable device onto which a vehicle may be driven for inspection of the vehicle, the device comprising:
a portable frame configured to support the vehicle and to permit the vehicle to be driven onto the frame;
at least two platforms disposed on the frame, the platforms providing support on which tires of the vehicle are positionable; and
a lifting system operably connected to at least one of the at least two platforms, the lifting system allowing the at least one platform to be controllably moveable to permit tilting of the vehicle to one side.

2. A device as in claim 1, wherein said lifting system operably connected to the at least two platforms, the lifting system allowing each of the at least two platforms to be independently controllable to permit tilting of the vehicle to one side.

3. A device as in claim 2, further comprising at least one ramp disposed at least one end of the frame, the at least one ramp providing a surface to permit the vehicles to be drivable onto the at least two platforms.

4. A device as in claim 3, wherein the at least one ramp is configured to be raisable and lowerable.

5. A device as in claim 3, wherein the at least one ramp is raisable and lowerable by the lifting system.

6. A device as in claim 3, wherein the at least one ramp comprises two rails that are in alignment with the at least two platforms to permit the vehicle to be driveable onto the at least two platforms.

7. A device as in claim 6, wherein the rails are configured to be foldable.

8. A device as in claim 6, wherein the rails have a support attached thereto to aid in the bearing of the load of the vehicle being driven onto the at least two platforms.

9. A device as in claim 3, wherein the at least one ramp comprise two ramps disposed at opposing ends of the frame.

10. A device as in claim 2, wherein the lifting system comprises a control unit operably connected to a drive unit coupled to the at least two platforms, the control unit engaging the drive unit when one of the at least two platforms is to be raised from the frame or lowered to the frame.

11. A device as in claim 2, wherein the lifting system comprises a hydraulic system.

12. A device as in claim 11, wherein the hydraulic system comprises a control unit connected to at least one pump for supplying power to engage the at least two platforms.

13. A device as in claim 12, wherein the at least one pump is operably connected to at least one cylinder that engages each of the at least two platforms.

14. A device as in claim 13, wherein the at least one cylinder comprises two pairs of cylinders disposed in the frame, each of the pairs being attached vertically beneath one of the at least two platforms.

15. A device as in claim 13, wherein the at least one cylinder comprises two cylinders positioned within the frame at an angle, each of the two cylinders operably connected to a swing arm disposed between the frame and one of the at least two platforms.

16. A device as in claim 12, wherein the at least one pump comprises a primary pump and a secondary pump, the secondary pump supplying power to engage the at least two platforms when the primary pump is taken out of service.

17. A device as in claim 11, further comprising batteries operably connected to the hydraulic system, the batteries supplying power to hydraulic system.

18. A device as in claim 17, further comprising a generator in communication with the batteries, the batteries being rechargeable by the generator.

19. A device as in claim 2, wherein the frame has a tongue and a coupler disposed thereto to permit the trailer to be hitched to a towing vehicle.

20. A device as in claim 19, further comprising a kill switch disposed on the frame to prevent the lifting system from operating when the trailer is in transit.

21. A device as in claim 20, wherein the coupler is removable from the tongue and the kill switch is operably disposed on the tongue so that when the coupler is engaged on the tongue, the kill switch is activated, and when the coupler is removed from the tongue, the kill switch is deactivated.

22. A device as in claim 1, wherein the frame is disposed on a plurality of axles having tires disposed thereto to permit the trailer to be mobile.

23. A device as in claim 22, wherein the plurality of axles comprise three axles centrally located under the frame.

24. A device as in claim 23, wherein a plurality of retractable jacks are disposed at opposing ends of the frames, the jacks are extendable to stabilize the trailer when in use and are retractable to a traveling position when the trailer is to be placed in transit.

25. A device as in claim 2, wherein the lifting system allowing each of the at least two platforms to be independently raisable above the frame and lowerable to the frame to permit tilting of the vehicle to one side.

26. A trailer onto which a vehicle may be driven for inspection of the vehicle, the trailer comprising:
a portable frame having two opposing ends and two sides;
at least two platforms disposed on the frame, the platforms providing support on which tires of the vehicle are positionable;
at least one ramp disposed at least one of the ends of the frame, the at least one ramp providing a surface to permit the vehicles to be drivable onto the at least two platforms; and
a lifting system operably connected to the at least two platforms, the lifting system allowing each of the at least two platforms to be independently raisable above the frame and lowerable to the frame to permit tilting of the vehicle to one side.

27. A trailer as in claim 26, wherein the lifting system comprises a control unit operably connected to a drive unit coupled to the at least two platforms, the control unit engaging the drive unit when one of the at least two platforms is to be raised from the frame or lowered to the frame.

28. A trailer as in claim 27, wherein the lifting system comprises a hydraulic system.

29. A trailer as in claim 28, wherein the drive unit comprises at least one pump operably connected to at least one cylinder that engages each of the at least two platforms, the at least one pump for supplying power to at least one cylinder to raise and lower the at least two platforms.

30. A trailer as in claim 29, wherein the at least one cylinder comprises two pairs of cylinders disposed in the frame, each of the pairs being attached vertical beneath one of the at least two platforms.

31. A trailer as in claim 29, wherein the at least one cylinder comprises two cylinders positioned within the frame at an angle, each of the two cylinders operably connected to a swing arm disposed between the frame and one of the at least two platforms.

32. A trailer as in claim 29, wherein the at least one ramp is raisable and lowerable by the hydraulic lifting system.

33. A trailer as in claim 29, wherein the hydraulic lifting system includes at least one ramp cylinder operably engaging the at least one ramp, the at least one ramp cylinder in communications with the at least one pump.

34. A trailer as in claim 33, wherein the at least one ramp comprise two ramps disposed at the two opposing ends of the frame.

35. A trailer as in claim 26, further comprising a kill switch disposed on the frame to prevent the lifting system from operating when the trailer is in transit.

36. A trailer as in claim 35, wherein the coupler is removable from the tongue and the kill switch is operably disposed on the tongue so that when the coupler is engaged on the tongue, the kill switch is activated, and when the coupler is removed from the tongue, the kill switch is deactivated.

37. A portable device onto which a vehicle may be driven for inspection of the vehicle, the device comprising:
a portable frame to support the vehicle and to permit the vehicle to be driven onto the frame;
a vehicle support disposed on the frame, the vehicle support providing a base on which tires of the vehicle are positionable; and
a lifting system operably connected to the vehicle support, the lifting system allowing the vehicle support to be controllably moveable to permit tilting of the vehicle to one side.

38. A device as in claim 37, further comprising at least one ramp disposed at least one end of the frame, the at least one ramp providing a surface to permit the vehicles to be drivable onto the vehicle support.

39. A device as in claim 38, wherein the at least one ramp is raisable and lowerable by the lifting system.

40. A device as in claim 38, wherein the at least one ramp comprise two ramps disposed at opposing ends of the frame.

41. A device as in claim 37, wherein the lifting system comprises a control unit operably connected to a drive unit coupled to the vehicle support, the control unit engaging the drive unit when one of the vehicle support is to tilt a vehicle.

42. A device as in claim 41, wherein the lifting system comprises a hydraulic system.

43. A device as in claim 37, further comprising a kill switch disposed on the frame to prevent the lifting system from operating when the portable device is in transit.
